(19) United States
(12) Patent Application Publication
(10) Pub. No.: US 2026/0064928 A1
(43) Pub. Date: Mar. 5, 2026

(54) PARAMETER GENERATION METHOD AND PARAMETER GENERATION APPARATUS FOR PRINTER

(71) Applicant: Wistron Corporation, New Taipei City (TW)

(72) Inventors: Tung Chen Tsou, New Taipei City (TW); Guan Chun Chen, New Taipei City (TW); Kuo Jen Chen, New Taipei City (TW)

(73) Assignee: Wistron Corporation, New Taipei City (TW)

(21) Appl. No.: 18/954,575

(22) Filed: Nov. 21, 2024

(30) Foreign Application Priority Data
Aug. 30, 2024 (TW) 113132960

(51) Int. Cl. G06F 30/373; G06F 30/27; G06F 30/39; G06F 111/04; G06F 113/10; G06F 115/12; G06F 117/12; G06F 119/22

(52) U.S. Cl. CPC G06F 30/373; G06F 30/27; G06F 30/39; G06F 2111/04; G06F 2113/10; G06F 2115/12; G06F 2117/12; G06F 2119/22

(57) ABSTRACT

A parameter generation method and a parameter generation apparatus for a printer are provided. By inputting target solder paste amount data into a first machine learning model, the first machine learning model outputs multiple predicted process parameters for the printer. By inputting multiple predicted process parameters into a second machine learning model, the second machine learning model outputs predicted solder paste amount data for the printer. Weights of the first machine learning model are updated according to the minimization of a prediction error. The prediction error is an error between the target solder paste amount data and the predicted solder paste amount data. By inputting the target solder paste amount data into the updated first machine learning model, the updated first machine learning model outputs multiple new process parameters used to control the operation of the printer. Therefore, the operational efficiency can be improved.

### CROSS-REFERENCE TO RELATED APPLICATION

This application claims the priority benefit of Taiwan application serial no. 113132960, filed on Aug. 30, 2024. The entirety of the above-mentioned patent application is hereby incorporated by reference herein and made a part of this specification.

### BACKGROUND

### Technical Field

The disclosure relates to a process with surface mount technology (SMT), and in particular to a parameter generation method and a parameter generation apparatus for printers.

### Description of Related Art

Surface mount technology (SMT) is an essential key process in the electronics industry. This technology primarily involves attaching an electronic element directly to the surface of a printed circuit board (PCB), offering advantages such as high density, high efficiency, and low cost. This technology is widely applied in fields like consumer electronics, communications, automotive, and medical industries.

However, the SMT process involves numerous complex parameters, and even slight changes in these parameters can significantly affect product quality and reliability. Conventionally, setting SMT process parameters relies mainly on engineers' experience and trial-and-error methods, which is time-consuming and labor-intensive, making it challenging to achieve optimal results.

### SUMMARY

The disclosure provides a parameter generation method and a parameter generation apparatus for a printer to offer suitable process parameters.

A parameter generation method for a printer according to the embodiments of the disclosure includes (but is not limited to) the following steps. A target solder paste amount data is input into a first machine learning model, and the first machine learning model outputs multiple predicted process parameters for the printer. The predicted process parameters are input into a second machine learning model, and the second machine learning model outputs a predicted solder paste amount data for the printer. The second machine learning model is trained to learn an association between multiple solder paste amount samples and multiple parameter samples. A weight of the first machine learning model is updated according to a minimization of a prediction error. The prediction error is an error between the target solder paste amount data and the predicted solder paste amount data. The target solder paste amount data is input into the updated first machine learning model, and the updated first machine learning model outputs multiple new process parameters, which are used to control the operation of the printer.

A parameter generation apparatus for a printer according to the embodiments of the disclosure includes (but is not limited to) a storage and a processor. The storage is used to store a program code. The processor is coupled to the storage. The processor is configured to load the program code and execute the following steps. A target solder paste amount data is input into a first machine learning model, and the first machine learning model outputs multiple predicted process parameters for the printer. The predicted process parameters are input into a second machine learning model, and the second machine learning model outputs a predicted solder paste amount data for the printer. The second machine learning model is trained to learn an association between multiple solder paste amount samples and multiple parameter samples. A weight of the first machine learning model is updated according to a minimization of a prediction error. The prediction error is an error between the target solder paste amount data and the predicted solder paste amount data. The target solder paste amount data is input into the updated first machine learning model, and the updated first machine learning model outputs multiple new process parameters, which are used to control the operation of the printer.

Based on the above, the parameter generation method and the parameter generation apparatus for the printer according to the embodiments of the disclosure can input the predicted process parameters generated by the first machine learning model into the second machine learning model, and update the first machine learning model based on minimizing the prediction error between the target solder paste amount data input into the first machine learning model and the predicted solder paste amount data generated by the second machine learning model. Then, the updated first machine learning model can be used to generate new process parameters. As a result, the printer can operate using the new process parameters, improving operational efficiency, reducing the chance of misjudgment, and minimizing material waste.

To make the above features and advantages of the disclosure more apparent and understandable, embodiments are provided below, along with detailed descriptions using the accompanying drawings.

### BRIEF DESCRIPTION OF THE DRAWINGS

FIG. 1 is a block diagram of elements of a parameter generation apparatus according to an embodiment of the disclosure.

FIG. 2 is a flowchart of a parameter generation method according to an embodiment of the disclosure.

FIG. 3 is a schematic diagram of the first machine learning model and the second machine learning model according to an embodiment of the disclosure.

FIG. 4 is a schematic diagram of the output adjustment of the first machine learning model according to an embodiment of the disclosure.

FIG. 5 is a schematic diagram illustrating a step function and a sigmoid function according to an embodiment of the disclosure.

FIG. 6 is a schematic diagram illustrating a positioning position according to an embodiment of the disclosure.

FIG. 7 is a schematic diagram illustrating an acceptance screening according to an embodiment of the disclosure.

FIG. 8 is a schematic diagram of a third machine learning model according to an embodiment of the disclosure.

FIG. 9 is a schematic diagram illustrating the opening ratio of holes according to an embodiment of the disclosure.

FIG. 10 is a schematic diagram illustrating the regional prediction of solder paste amounts according to an embodiment of the disclosure.

FIG. 11 is a schematic diagram comparing the actual and predicted solder paste amounts according to an embodiment of the disclosure.

FIG. 12 is a flowchart of model diagnosis and adjustment according to an embodiment of the disclosure.

FIG. 13 is a schematic diagram illustrating grouping according to an embodiment of the disclosure.

FIG. 14 is a schematic diagram illustrating hierarchical clustering according to an embodiment of the disclosure.

FIG. 15 is an experimental diagram illustrating verification according to an embodiment of the disclosure.

### DESCRIPTION OF THE EMBODIMENTS

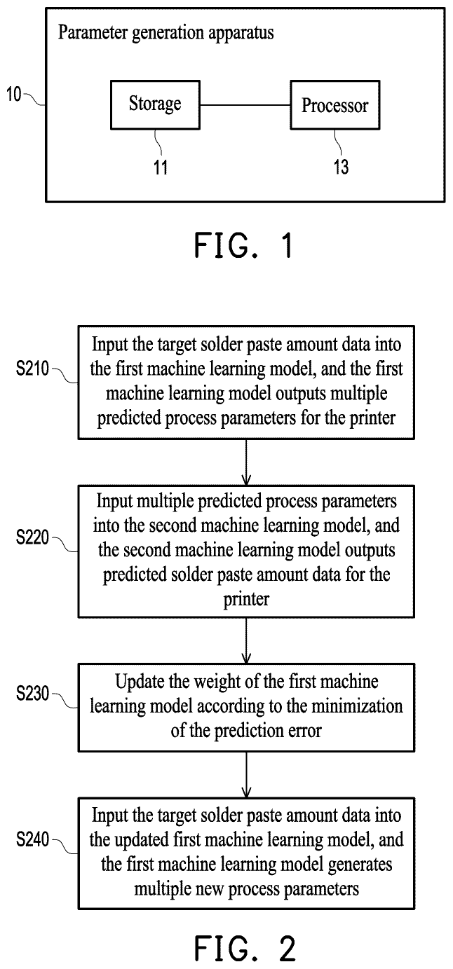

FIG. 1 is a block diagram of elements of a parameter generation apparatus 10 according to an embodiment of the disclosure. Referring to FIG. 1, the parameter generation apparatus 10 includes (but is not limited to) a storage 11 and a processor 13. The parameter generation apparatus 10 can be a mobile phone, tablet, laptop, desktop computer, server, voice assistant apparatus, smart home appliance, wearable apparatus, process equipment, or other electronic apparatuses.

The storage 11 can be any type of fixed or removable Random Access Memory (RAM), Read Only Memory (ROM), flash memory, traditional Hard Disk Drive (HDD), Solid-State Drive (SSD), or similar elements. In one embodiment, the storage 11 is used to store program codes, software modules, configuration settings, data (e.g., solder paste amount data, process parameters, features, or physical information), or files, as will be detailed in subsequent embodiments.

The processor 13 is coupled to the storage 11. The processor 13 can be a central processing unit (CPU), graphics processing unit (GPU), or other programmable general-purpose or specific-purpose microprocessors, digital signal processors (DSP), programmable controllers, field programmable gate arrays (FPGA), application-specific integrated circuits (ASIC), neural network accelerators, or other similar elements, or a combination of the aforementioned elements. In one embodiment, the processor 13 is used to perform all or part of the operations of the parameter generation apparatus 10, and it can load and execute the program codes, software modules, files, and data stored in the storage 11.

Below, the method in the embodiments of the disclosure will be described in conjunction with the apparatuses, elements, and modules of the parameter generation apparatus 10. The flow of the method can be adjusted according to specific implementations and is not limited thereto.

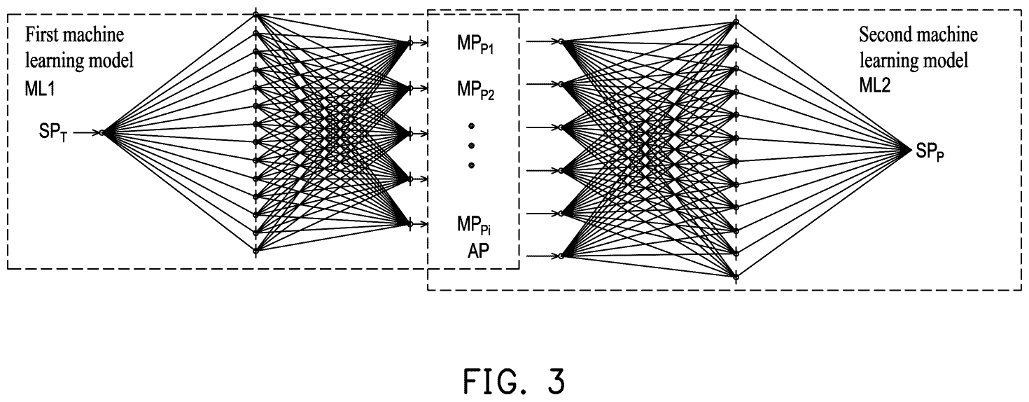

FIG. 2 is a flowchart of a parameter generation method according to an embodiment of the disclosure. Referring to FIG. 2, the processor 13 inputs target solder paste amount data into the first machine learning model, and the first machine learning model outputs multiple predicted process parameters for a printer (step S210). Specifically, the printing operation of the printer used in surface mount technology (SMT) includes: placing a metal board (e.g., a steel plate or other metallic material) on a printed circuit board (PCB); aligning the holes of the metal board with the pads of the PCB; and applying/printing the solder paste onto the PCB through the holes of the metal board using a squeegee.

The target solder paste amount data includes the desired amount of solder paste to be applied/printed onto the PCB during the printing operation. The solder paste amount can be expressed as a percentage, volume, or area. For example, expressing the solder paste amount as a percentage represents the proportion of the solder paste amount relative to a reference amount. For instance, 100% indicates that the solder paste amount is equal to the reference amount. The reference amount can be predefined or adjusted as needed.

The predicted process parameters refer to the process parameters that are predicted/output/generated by the first machine learning model. The types of process parameters mentioned in this document may include pressure, print speed, separate speed, separation distance, print gap, and clean rate. However, other types of process parameters may also be possible.

The first machine learning model is a model trained by a machine learning algorithm. The first machine learning model can be trained to understand the association between solder paste amount and process parameters. The machine learning algorithm may be, for example, an artificial neural network (ANN), eXtreme Gradient Boosting (XGboost), support vector regression (SVR), convolutional neural network (CNN), or other algorithms. During the training process, the machine learning algorithm adjusts the parameters (e.g., weights) in the model based on the minimization of a loss function (e.g., a function based on the error between real data and output data). In the initial stage of training, the model may adopt default or initial parameters.

FIG. 3 is a schematic diagram of a first machine learning model ML1 and a second machine learning model ML2 according to an embodiment of the disclosure. Referring to FIG. 3, the first machine learning model ML1 is a single-input and multiple-output model. That is, the first machine learning model ML1 only inputs a target solder paste amount data SP_{T} and outputs multiple predicted process parameters MP_{P1} to MP_{Pi} (i being a positive integer greater than one). For example, if i is 6, the predicted process parameter MP_{P1} is the value for pressure, MP_{P2} is the value for print speed, MP_{P3} is the value for separate speed, MP_{P4} is the value for separation distance, MP_{P5} is the value for print gap, and MP_{P6} is the value for clean rate. However, the predicted process parameters are not limited to these.

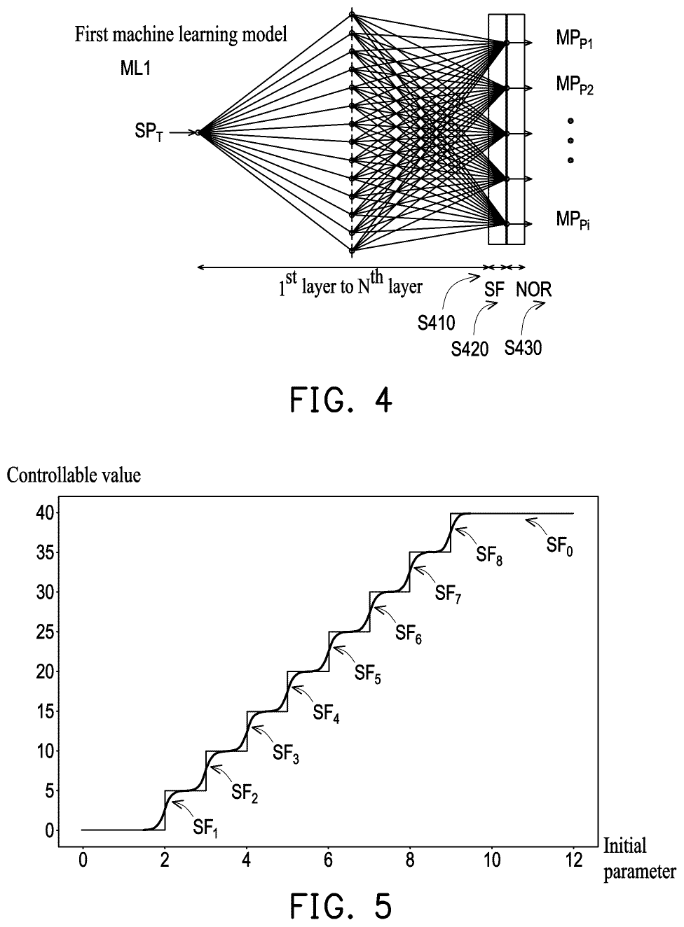

FIG. 4 is a schematic diagram of the output adjustment of the first machine learning model ML1 according to an embodiment of the disclosure. Referring to FIG. 4, the processor 13 can use the first machine learning model ML1 to output initial parameters (step S410). Specifically, the first machine learning model ML1 may include N layers, where N is a positive integer greater than one, and the number of layers N can be adjusted according to actual needs. These N layers may be fully connected layers, convolutional layers, pooling layers, etc. The initial parameters are the process parameters generated by the first machine learning model ML1 at the beginning. However, the values of the initial parameters may exceed the range of the training data, which could affect their reliability.

Table (1) shows the process parameters and their value ranges:

TABLE (1)

| Process Parameters | Value Range |
|---|---|
| Print speed (mm/s) | 0 to 200 (minimum unit: 1) |
| Pressure (kg) | 0 to 20 (minimum unit: 0.2) |
| Print gap (mm) | −1, −1 (minimum unit: 0.1) |
| Clean rate (cycles) | Integer of 1 or more (minimum unit: 1) |
| Separate speed (mm/s) | 0.1 to 5 (minimum unit: 0.1) |
| Separation distance (mm) | 0.1 to 5 (minimum unit: 0.1) |

The minimum unit can also be referred to as the basic unit or foundational unit. For example, with print speed, the values increase from 20, 25, 30, 35, 40, 45, to 50 in increments of the minimum unit (i.e., 5).

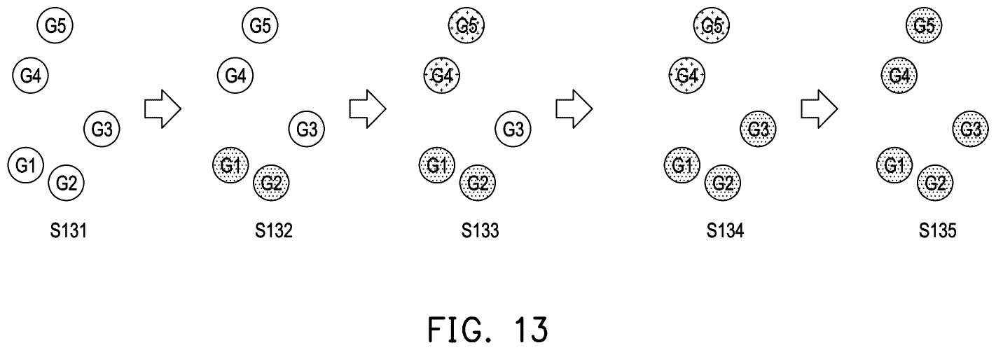

The processor 13 can convert the initial parameters into controllable values using a transfer function SF (step S420). Specifically, the transfer function is a step function. For example, FIG. 5 is a schematic diagram illustrating a step function and a sigmoid function according to an embodiment of the disclosure. Referring to FIG. 13, the horizontal axis corresponds to the initial parameters, and the vertical axis corresponds to the controllable values after being converted by a step function SF₀. It should be noted that the units corresponding to the horizontal and vertical axes must match the types of process parameters, as shown in Table (1), but are not limited to this.

The processor 13 can define the step function SF₀ as a step-like curve, with fixed function values within different value ranges (corresponding to the domain of the function f(x), i.e., the initial parameters). The mathematical expression of the step function SF₀ is:

$$f ( x ) = \{ \begin{matrix}Upper limit of value range , if the interger part of ( x ) * minimal unit > upper limit of value range \\ the interger part of ( x ) * minimum unit , if otherwise \\ lower limit of value range , if the interger part of ( x ) * minimum unit > lower limit of value range\end{matrix} . \qquad ( 1 )$$

Taking FIG. 5 as an example, when the value of the initial parameter is between 0 and 2, the controllable value after conversion by the step function SF₀ is 0*5=0 (e.g., if the value is 0.7, it is rounded down in this example, so it becomes 0); when the value of the initial parameter is between 2 and 3 (e.g., if the value is 2.3, it is rounded down in this example, so it becomes 2), the controllable value after conversion by the step function SF₀ is 2*5=10; when the value of the initial parameter is between 3 and 4 (e.g., if the value is 3.8, it is rounded down in this example, so it becomes 3), the controllable value after conversion by the step function SF₀ is 4*5=20. In this manner, when the initial parameter value exceeds 9, the controllable value after conversion by the step function SF₀ is always 40. It should be noted that the values of the domain and range shown in FIG. 5 are only for illustrative purposes and can be changed according to actual requirements.

In one embodiment, the step function is formed by adding multiple sigmoid functions. A step function may have situations where it is not differentiable, or its derivative is zero, leading to a vanishing gradient. To avoid this issue, referring to FIG. 5 as an example, the step function SF₀ is formed by adding multiple sigmoid functions SF₁, SF₂, SF₃, SF₄, SF₅, SF₆, SF₇, and SF₈. That is, the processor 13 can approximate the step function SF₀ by adding multiple different sigmoid functions SF₁, SF₂, SF₃, SF₄, SF₅, SF₆, SF₇, and SF₈. The sigmoid function SF₁ maps any real number input to the range of 0 to 5; the sigmoid function SF₂ maps any real number input to the range of 5 to 10; and so on, with the sigmoid function SF₈ mapping any real number input to the range of 35 to 40.

Referring to FIG. 4, the processor 13 can normalize (NOR) the controllable values into the predicted process parameters (step S430). Specifically, normalization refers to the process of scaling the data to a specific range. For example, MinMaxScaler uses the following equation (2) to scale the data to the range of 0 to 1:

$$z\_scaled = ( z - z\_min ) / ( z\_max - z\_min ) \qquad ( 2 )$$

where z_scaled is the scaled value (i.e., the value of the predicted process parameter), z is the original value (i.e., the controllable value), z_min is the minimum value of the original data, and z_max is the maximum value of the original data. It should be noted that the minimum value z_min and maximum value z_max in equation (2) can be adjusted according to actual requirements.

Referring to FIG. 2, the processor 130 inputs the multiple predicted process parameters into the second machine learning model, and the second machine learning model outputs the predicted solder paste amount data for the printer (step S220). Specifically, the second machine learning model is a model trained using a machine learning algorithm. The machine learning algorithm may be, for example, an Artificial Neural Network (ANN), eXtreme Gradient Boosting (XGboost), Support Vector Regression (SVR), Convolutional Neural Network (CNN), or other algorithms. The second machine learning model can be trained to understand the association between multiple solder paste amount samples and multiple parameter samples. The dataset used for training and/or validation includes solder paste amount samples and multiple parameter samples.

The solder paste amount samples include the historical solder paste amounts applied/printed onto the PCB during the printing operation. The solder paste amount can be expressed as a percentage, volume, or area. For example, expressing the solder paste amount as a percentage represents the proportion of the solder paste amount relative to a reference amount. For instance, 100% indicates that the solder paste amount is equal to the reference amount. The reference amount can be predefined or adjusted as needed. In addition, each solder paste amount sample corresponds to a set of parameter samples. The parameter samples are training samples of process parameters. A set of parameter samples (including multiple parameter samples) is used by the printer during the printing operation, and the value of the solder paste amount used in that operation serves as a solder paste amount sample corresponding to the set of parameter samples. Since the solder paste amount sample and its corresponding set of parameter samples are known, the machine learning algorithm can analyze the labeled solder paste amount samples (e.g., the solder paste amount for known process parameters) and establish the association between the solder paste amount samples (as output samples) and the parameter samples (as input samples). The second machine learning model is the model constructed after training and learning, and it can infer the corresponding predicted solder paste amount data (i.e., the output of the model) for the data to be evaluated (e.g., the (predicted) process parameters to be evaluated, which serve as the input of the model).

Referring to FIG. 3, the second machine learning model ML2 is a multi-input and single-output model. That is, the second machine learning model ML2 inputs multiple predicted process parameters MP_{P1} to MP_{Pi} (i being a positive integer greater than one) and outputs a predicted solder paste amount data SPP.

In one embodiment, the processor 13 can input multiple predicted process parameters MP_{P1} to MP_{Pi} and auxiliary parameters AP into the second machine learning model ML2. That is, in addition to the predicted process parameters MP_{P1} to MP_{Pi}, the inputs to the second machine learning model ML2 also include auxiliary parameters AP. Types of auxiliary parameters include temperature, humidity, and the positioning position of the metal board in the printer. The temperature and humidity are environmental parameters sensed during the printing operation of the printer.

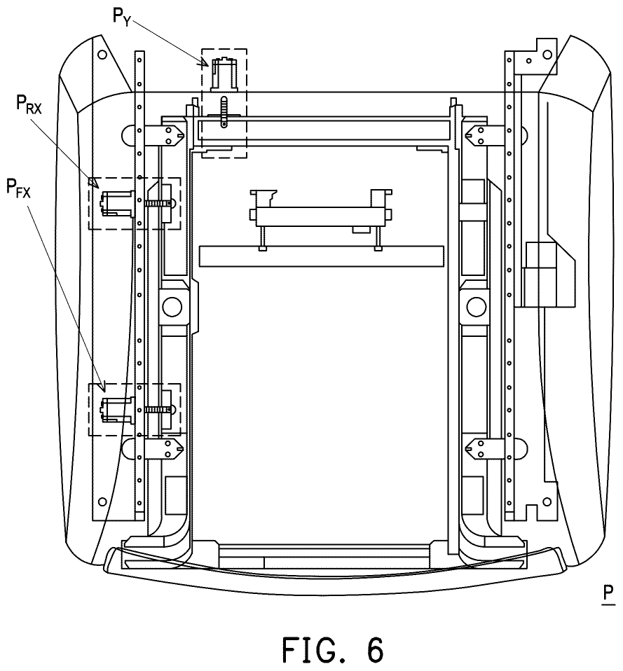

FIG. 6 is a schematic diagram illustrating the positioning position according to an embodiment of the disclosure. Referring to FIG. 6, the printer P includes a horizontal axis actuator, a rear vertical axis actuator, and a front vertical axis actuator. The horizontal axis actuator is used to position the metal board along the horizontal axis (a position P_{Y}), and the rear and front vertical axis actuators are used to position the metal board along the vertical axis (positions P_{RX} and P_{FX}, respectively). These positioning positions P_{Y}, P_{RX}, and P_{FX} are used to align the holes of the metal board with the pads on the printed circuit board (PCB) during the printing operation. The positioning positions P_{Y}, P_{RX}, and P_{FX} can be represented as coordinates, relative distances, or relative positions. These positioning positions may affect the amount of solder paste applied.

Additionally, in the training of the second machine learning model, the dataset also includes auxiliary samples. The auxiliary samples consist of measured data for temperature, humidity, and actuator positioning positions during the printing operation. Since the solder paste amount samples, their corresponding set of parameter samples, and the auxiliary samples are known, the machine learning algorithm can analyze the labeled solder paste amount samples (e.g., the solder paste amounts corresponding to known process and auxiliary parameters) and establish the association between the solder paste amount samples (as output samples), parameter samples, and auxiliary samples (as input samples). The second machine learning model is the model constructed after training and learning and can be used to infer the corresponding predicted solder paste amount data (i.e., the model's output) for the data to be evaluated (e.g., the (predicted) process parameters and auxiliary parameters to be evaluated, which serve as the model's input).

For example, the model inputs may include “front squeegee print pressure”: 8.4 kg, “rear squeegee print pressure”: 9.0 kg, “print gap”: −0.6 mm, “front squeegee print speed”: 60 mm/s, “rear squeegee print speed”: 60 mm/s, “separation distance”: 0.4 mm, “separation speed”: 0.2 mm/s, and “cleaning frequency”: 1.0 boards. The model outputs the area percentage (area detection value/area target value): 100.3%, height percentage (height detection value/height target value): 101.3%, and volume percentage (volume detection value/volume target value): 103.9%.

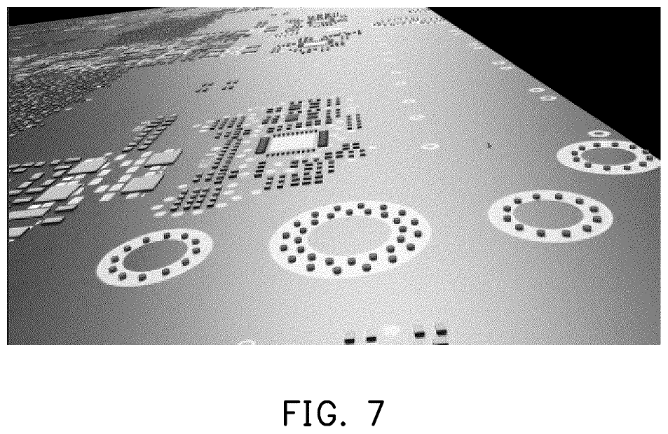

FIG. 7 is a schematic diagram illustrating acceptance screening according to an embodiment of the disclosure. Referring to FIG. 7, the solder paste inspection (SPI) machine can inspect the print quality of the circuit board after the printing operation is completed. For example, the 3D view of the circuit board shown can highlight problematic pads in a distinctive color. Additionally, the SPI machine can measure the actual solder paste data on the circuit board. The actual solder paste data includes the height, area, and/or volume of the solder paste. The acceptance criteria for the second machine learning model can be that the difference between the predicted solder paste amount data and the actual data (in terms of area, height, and/or volume) is less than a corresponding threshold value (e.g., 10%, 5%, or 3%). That is, only the second machine learning models with a difference less than the corresponding threshold value are used.

Referring to FIG. 2, the processor 13 updates the weights of the first machine learning model according to the minimization of the prediction error (step S230). Specifically, the prediction error is the difference between the target solder paste amount data and the predicted solder paste amount data. In machine learning, the goal of model training is to minimize the prediction error to improve the accuracy of the model's predictions. This process involves several key factors: loss function, optimization algorithm, gradient, iterative updates, and convergence.

In one embodiment, the processor 13 can use a loss function to determine the prediction error. The loss function represents half of the square of the numerical difference between the target solder paste amount data and the predicted solder paste amount data. The mathematical expression for the loss function LOSS is as follows:

LOSS=½[target solder paste amount data−predicted solder paste amount data]² (3)

where the predicted solder paste amount data is generated/output by inputting the predicted process parameters (and auxiliary parameters) into the second machine learning model.

The optimization algorithm is used to adjust the parameters of the model to minimize the value of the loss function. Examples of optimization algorithms include gradient descent, Newton's method, or Adam. The gradient is the derivative of the loss function at a certain point and indicates the direction and magnitude of change of the loss function at that point. The optimization algorithm uses gradient information to guide the update of parameters. Additionally, the training of the first machine learning model is an iterative process. In each iteration, the optimization algorithm updates the model's parameters (e.g., node weights) based on the gradient information, gradually reducing the loss function. Training stops when the loss function no longer significantly decreases or a preset stopping condition is met. At this point, the parameters of the first machine learning model reach a relatively optimized state, and the updated first machine learning model is generated.

Referring to FIG. 2, the processor 13 inputs the target solder paste amount data into the updated first machine learning model, and the updated first machine learning model outputs multiple new process parameters (step S240). Specifically, the multiple new process parameters are used to control the operation of the printer (e.g., the aforementioned printing operations). The processor 13 inputs the target solder paste amount data into the updated first machine learning model, and the new process parameters are inferred or predicted by the updated first machine learning model to meet the target solder paste amount data.

For example, the model inputs may include area percentage (area detection value/area target value): 100%, height percentage (height detection value/height target value): 100%, and volume percentage (volume detection value/volume target value): 100%. The model outputs may include “front squeegee print pressure”: 8.8 kg, “rear squeegee print pressure”: 9.6 kg, “print gap”: −0.4 mm, “front squeegee print speed”: 45 mm/s, “rear squeegee print speed”: 45 mm/s, “separation distance”: 0.4 mm, “separation speed”: 0.2 mm/s, and “cleaning frequency”: 2.0 boards.

In one embodiment, the processor 13 may generate operation instructions or operation settings based on the new process parameters, and the printer can use these operation instructions or settings to carry out printing operations accordingly under the new process parameters.

The solder paste amount data in the aforementioned embodiment can refer to the printing operation for an entire metal board. For instance, this may be referred to as the total board solder paste amount or the solder paste amount used for the entire board. The following introduces a method for providing the appropriate solder paste amount for one or more of the multiple pads on a metal board. FIG. 8 is a schematic diagram of the third machine learning model according to an embodiment of the disclosure. Referring to FIG. 8, the processor 13 inputs multiple to-be-evaluated features EF₁, EF₂ to EFⱼ (j being a positive integer greater than one) into a third machine learning model ML3, which generates the solder paste amount data SP_{P2} for the holes in the printer. Specifically, the third machine learning model ML3 is a model trained using a machine learning algorithm. The machine learning algorithm may be, for example, an artificial neural network (ANN), eXtreme Gradient Boosting (XGboost), support vector regression (SVR), convolutional neural network (CNN), or other algorithms. The third machine learning model ML3 can be trained to learn the association between multiple hole features and the solder paste amount.

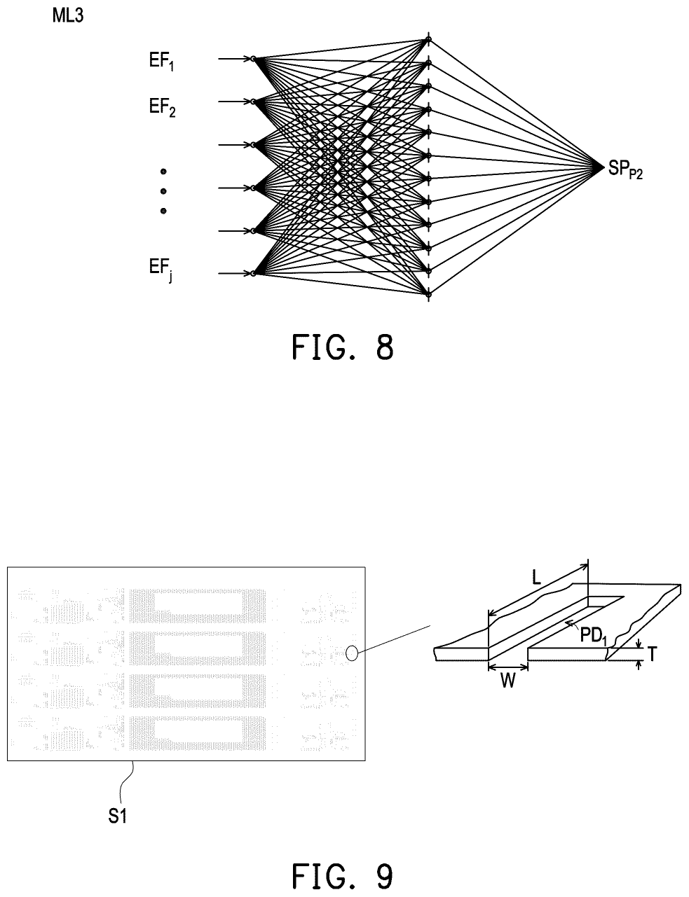

The hole features include the opening ratio of multiple holes on a metal board and the distribution positions of these holes on the metal board. For example, FIG. 9 is a schematic diagram illustrating the opening ratio according to an embodiment of the disclosure. Referring to FIG. 9, the opening ratio may include the width-to-thickness ratio and the area ratio of the hole. Taking a hole PD₁ on a metal board S1 as an example, the width-to-thickness ratio of the hole PD₁ is defined as a width W of the hole PD₁ divided by a thickness T of the metal board S1. The area ratio of the hole PD₁ is defined as the area of the pad (i.e., the width W of the hole PD₁ multiplied by a length L of the hole PD₁) divided by the area of the hole wall (i.e., 2*(W+L)*the thickness T of metal board S1). The distribution position of the hole PD₁ on the metal board S1 is the location of the hole PD₁ on the metal board S1, which can be expressed using coordinates, relative distances, or relative positions.

The hole solder paste amount data includes the solder paste amounts used for multiple holes. After the printing operation, the solder paste inspection (SPI) machine can measure the solder paste amount for each of the multiple holes and store the area, volume, or percentage relative to the reference amount. The solder paste amount data for a specific hole or pad can be derived from the total solder paste amount on the entire metal board multiplied by the ratio of each pad's contribution to the total solder paste amount.

Additionally, each set of hole solder paste amount data corresponds to multiple hole features. The printer uses the same process parameters during the printing operation to fill solder paste into each hole. Since the hole solder paste amount data and their corresponding set of hole features are known, the machine learning algorithm can analyze the labeled hole solder paste amount data (e.g., the solder paste amount for holes or pads with known features) and establish the association between the solder paste amount (as the output sample) and the hole features (as the input sample). The third machine learning model is the model constructed after training and learning, and it can be used to infer the corresponding hole solder paste amount data for the data to be evaluated (e.g., the to-be-evaluated features EF₁, EF₂ to EFⱼ, such as the opening ratio and distribution position of the holes on the metal board, which serve as the input of the model). The proportion of each pad's contribution to the total solder paste amount for the entire board is the target solder paste amount of that pad/hole divided by the total target solder paste amount for all the pads/holes on the same metal board.

For example, Table (2) shows the experimental data for the model inputs and the model outputs:

TABLE 2

| Model Input | | | | | | |
|---|---|---|---|---|---|---|
| Width-to- | | Horizontal | Vertical | Model Output | | |
| thickness | Area | axis | axis | Area | Height | Volume |
| ratio | ratio | position | position | percentage | percentage | percentage |
| 10.41 | 2.9825 | 163.48 | 168.00 | 1.03 | 1.02 | 1.08 |
| 5.6 | 1.4634 | 79.06 | 41.78 | 1.02 | 1.05 | 1.09 |
| 13.97 | 3.8872 | 30.8938 | 32.7351 | 1.06 | 0.97 | 1.05 |

FIG. 10 is a schematic diagram illustrating regional prediction of solder paste amounts according to an embodiment of the disclosure. Referring to FIG. 10, the metal board can be divided into multiple sections, such as the nine sections shown: G11, G12, G13, G21, G22, G23, G31, G32, and G33. The prediction results may be as follows:

TABLE (3)

| | | |
|---|---|---|
| 1.10/1.48/6.10 | 1.09/1.51/6.11 | 1.08/1.41/5.69 |
| 1.02/1.14/4.57 | 1.05/1.24/4.95 | 1.01/1.14/4.57 |
| 1.08/1.41/5.69 | 1.08/1.51/6.11 | 1.09/1.48/6.10 |

Each cell in the table represents volume percentage/area percentage/width-to-thickness ratio.

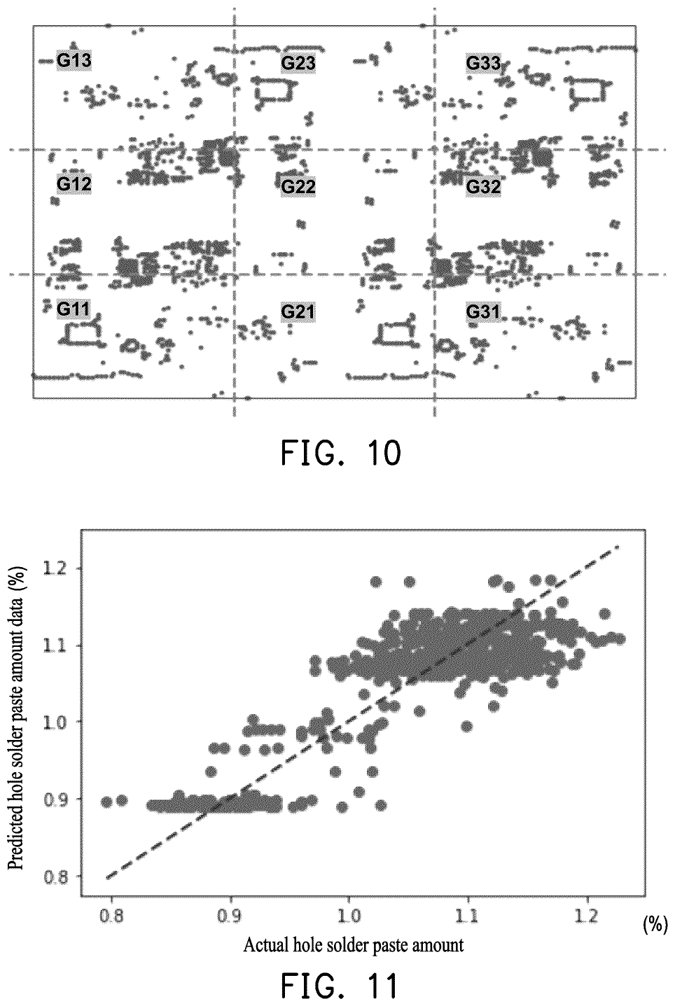

FIG. 11 is a schematic diagram comparing actual and predicted solder paste amounts according to an embodiment of the disclosure. Referring to FIG. 11, the error between actual and predicted values can be less than 10%, with a correlation greater than 0.87.

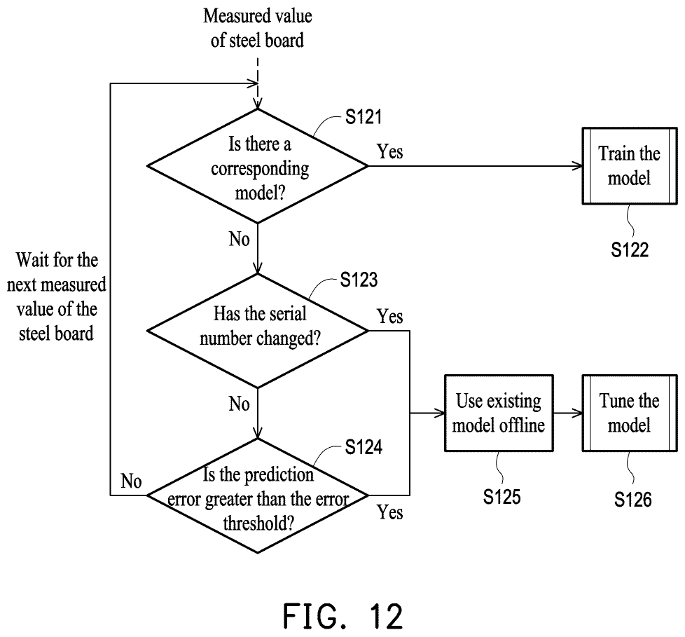

FIG. 12 is a flowchart illustrating model diagnosis and adjustment according to an embodiment of the disclosure. Referring to FIG. 12, the solder paste inspection (SPI) machine can measure the solder paste amounts on a steel board (i.e., metal board) or a printed circuit board (PCB), such as height, area, and/or volume of the solder paste, which serves as the measured value. The processor 13 can determine whether there is an existing artificial intelligence (AI) model (e.g., the first, second, or third machine learning models mentioned above) corresponding to this steel board or PCB (step S121). If no corresponding model exists, the processor 13 can perform model training (step S122). For example, data from the last 30 days for this steel board (e.g., hole features) can be collected, removing missing or abnormal values. The model is retrained only when the collected data exceeds thirty records and the parameter settings are greater than or equal to two. Finally, the error between the predicted area, height and/or volume, and the measured value is validated to confirm that the error is less than the corresponding threshold value (e.g., 10%, 5%, or 3%). If the validation results show that the error is less than the threshold value, the third machine learning model can go online.

If a corresponding model already exists, the processor 13 checks whether the work order number has changed (step S123). If it has not changed, the processor 13 checks whether the model's prediction error is greater than the threshold value (e.g., 10%, 5%, or 3%) (step S124). If the prediction error is greater than the threshold value, the processor 13 waits for the next measured value from the steel board.

If the prediction error exceeds the threshold value or the work order number has changed, the model is taken offline (step S125), and the model is further tuned using the measured values (step S126). For example, data from the most recent work order (e.g., hole features) is used, removing missing or abnormal values. The model is retrained only when the collected data exceeds five records. Finally, the predicted area, height, and/or volume is validated against the measured value to ensure the error is less than the corresponding threshold value (e.g., 10%, 5%, or 3%). If the validation results show that the error is less than the threshold value, the AI model can go online.

In one embodiment, the processor 13 can determine that the physical features of a metal board belong to a first group among multiple metal board groups. The physical features of the metal board may include the type, size, number of elements, number of holes, upper and lower limits of the hole width-to-thickness ratio, and/or upper and lower limits of the hole area ratio. For unknown or new metal boards, the processor 13 can obtain the measured values of the physical features of the metal board.

For the metal board groups, the processor 13 can provide multiple second machine learning models. As described previously, the second machine learning models will not be repeated here. Each second machine learning model corresponds to one set of historical metal board physical information, and the historical metal board physical information corresponding to one second machine learning model is different from the historical metal board physical information corresponding to another second machine learning model. A piece of historical metal board physical information refers to the measured values of the physical features of a known metal board. For example, the measured values corresponding to the metal board used as a training sample for the second machine learning model. Different metal boards may have different measured values for their physical features. Therefore, the processor 13 can train the training samples corresponding to different metal boards separately, thereby generating multiple second machine learning models. Alternatively, the model training can be done by other apparatuses, and the processor 13 can obtain multiple pre-trained second machine learning models.

Next, the processor 13 can cluster multiple pieces of historical metal board physical information into multiple metal board groups. The clustering method (also called clustering algorithm) can be the k-means algorithm, Gaussian mixture model (GMM), mean-shift clustering algorithm, hierarchical clustering, spectral clustering algorithm, DBSCAN (density-based spatial clustering of applications with noise), or other clustering algorithms. Clustering categorizes the historical metal board physical information and groups similar pieces of historical metal board physical information into the same metal board group.

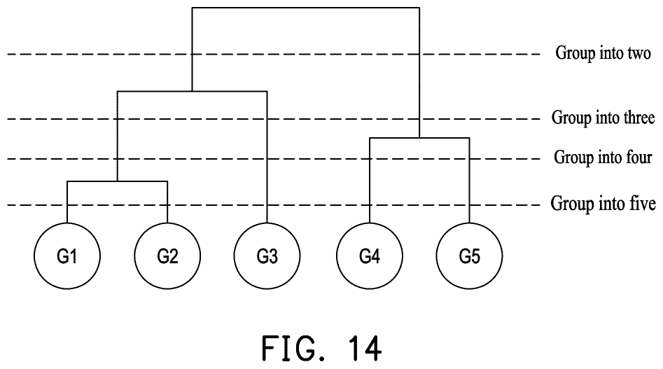

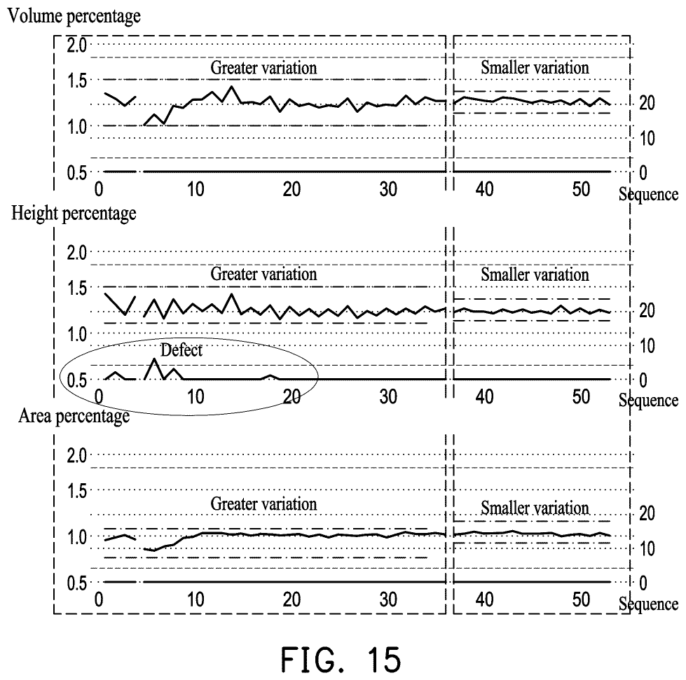

FIG. 13 is a schematic diagram illustrating clustering according to an embodiment of the disclosure, and FIG. 14 is a schematic diagram illustrating hierarchical clustering according to an embodiment of the disclosure. Referring to FIGS. 13 and 14, taking hierarchical clustering as an example, the processor 13 calculates the distances between samples (e.g., historical metal board physical information) (step S131). For example, Euclidean distance in a feature coordinate system. The processor 13 combines the nearest samples into a group, which then becomes a new combined sample. A sample G1 and a sample G2 are combined into a group (step S132). The processor 13 continues to calculate the distances between samples and/or combined samples, grouping the nearest samples and/or combined samples. A sample G4 and a sample G5 are combined into a group (step S133). The combined sample of G1 and G2 is then combined with a sample G3 to form a group (step S134). Finally, the combined sample of G1 to G3 is combined with the combined sample of G4 and G5 to form a group (step S135), so that all of the samples G1 to G5 become one combined sample. As shown in FIG. 14, the processor 13 determines the number of groups to be 5 by cutting based on the distances between the samples G1 to G5.

When a metal board group contains only one piece of metal board physical information (i.e., corresponding to a single metal board), the second machine learning model corresponding to that metal board physical information can be directly used as the representative model for that metal board group.

For the first group among multiple metal board groups, the processor 13 can select the second machine learning model with the smallest prediction error among the multiple second machine learning models corresponding to the first group. In other words, when a metal board group (e.g., the first group) has multiple pieces of metal board physical information (i.e., corresponding to multiple metal boards), the processor 13 can compare the prediction errors of the second machine learning models corresponding to these pieces of metal board physical information and choose the second machine learning model with the smallest prediction error as the representative model for that metal board group (i.e., the second machine learning model corresponding to the first group).

Only when the physical features of the metal board to be evaluated belong to the first group among multiple metal board groups does the processor 13 select the second machine learning model corresponding to the first group to generate the predicted solder paste amount data. For example, the processor 13 inputs the process parameters to be evaluated into the second machine learning model, and the second machine learning model outputs the predicted solder paste amount data for the printer.

FIG. 15 is an experimental validation diagram according to an embodiment of the disclosure. Referring to FIG. 15, the validation is conducted for volume percentage, height percentage, and area percentage of the solder paste amounts. The left half of the diagram shows the results using existing process parameters, while the right half shows the results using new process parameters generated by the updated first machine learning model. On the left half, the volume percentage of the solder paste amounts varies widely (ranging from 1.01 to 1.43), while on the right half, the variation in volume percentage is smaller (ranging from 1.21 to 1.31). The height percentage of the solder paste amounts on the left half also shows greater variation (ranging from 1.15 to 1.42) and even detects defects, whereas the variation in height percentage on the right half is smaller (ranging from 1.21 to 1.29). Similarly, the variation in area percentage on the left half is larger (ranging from 0.83 to 1.04), while the variation on the right half is smaller (ranging from 0.99 to 1.05). This demonstrates that the printing operation using the new process parameters results in smaller variation in the solder paste amounts and can avoid defects. Additionally, the printing operation using the new process parameters can improve efficiency (e.g., by 8%).

In summary, in the parameter generation method for a printer according to the embodiment of the disclosure, two machine learning models are used to update the model weights, and the updated machine learning models generate new process parameters. As a result, the amount of solder paste used in printing operations with the new process parameters can be close to or the same as the target solder paste amount. Additionally, this method can reduce the variation in solder paste amounts, decrease or avoid defects, and improve the efficiency of the printing operation.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A parameter generation method for a printer, comprising:
inputting a target solder paste amount data into a first machine learning model, wherein the first machine learning model outputs a plurality of predicted process parameters for the printer;
inputting the plurality of predicted process parameters into a second machine learning model, wherein the second machine learning model outputs a predicted solder paste amount data for the printer, and the second machine learning model is trained to learn an association between a plurality of solder paste amount samples and a plurality of parameter samples;
according to a minimization of a prediction error, updating a weight of the first machine learning model, wherein the prediction error is an error between the target solder paste amount data and the predicted solder paste amount data; and
inputting the target solder paste amount data into the updated first machine learning model, wherein the updated first machine learning model outputs a plurality of new process parameters, and the plurality of new process parameters are used to control an operation of the printer.

2. The parameter generation method for the printer according to claim 1, wherein updating the weight of the first machine learning model according to the minimization of the prediction error comprises:
using a loss function to determine the prediction error, wherein the loss function is a half a square of a numerical difference between the target solder paste amount data and the predicted solder paste amount data.

3. The parameter generation method for the printer according to claim 1, wherein the plurality of new process parameters comprise a plurality of printing parameters used in the operation of the printer, and the target solder paste amount data comprises a solder paste amount used for a metal board.

4. The parameter generation method for the printer according to claim 3, wherein a type of the plurality of printing parameters comprises a pressure, a print speed, a separate speed, a separation distance, a print gap, and a clean rate.

5. The parameter generation method for the printer according to claim 1, further comprising:
inputting a plurality of features to be evaluated into a third machine learning model, wherein the third machine learning model outputs a hole solder paste amount data for the printer, the third machine learning model is trained to learn an association between a plurality of hole features and a solder paste amount, the plurality of hole features comprises an opening ratio of a plurality of holes on a metal board and a plurality of distribution positions of the plurality of holes on the metal board, and the hole solder paste amount data comprises the solder paste amount used for the plurality of holes.

6. The parameter generation method for the printer according to claim 1, wherein the first machine learning model outputting the plurality of predicted process parameters for the printer comprises:
using the first machine learning model to output an initial parameter;
converting the initial parameter into a controllable value using a transfer function, wherein the transfer function is a step function; and
normalizing the controllable value into the predicted process parameter.

7. The parameter generation method for the printer according to claim 6, wherein the step function is formed by adding a plurality of sigmoid functions.

8. The parameter generation method for the printer according to claim 1, wherein inputting the plurality of predicted process parameters into the second machine learning model comprises:
inputting the plurality of predicted process parameters and an auxiliary parameter into the second machine learning model, wherein a type of the auxiliary parameter comprises a temperature, a humidity, and a positioning position of a metal board in the printer.

9. The parameter generation method for the printer according to claim 1, further comprising:
determining that a metal board physical feature belongs to a first group of a plurality of metal board groups; and
selecting the second machine learning model corresponding to the first group to generate the predicted solder paste amount data.

10. The parameter generation method for the printer according to claim 9, further comprising:
providing a plurality of the second machine learning models, wherein each of the plurality of second machine learning models corresponds to one of a plurality of historical metal board physical information, and the one of the plurality of historical metal board physical information corresponding to any of the plurality of second machine learning models differs from another one of the plurality of historical metal board physical information corresponding to another one of plurality of the second machine learning models;
grouping the plurality of historical metal board physical information into the plurality of metal board groups; and
for the first group of the plurality of metal board groups, selecting one of the plurality of second machine learning models corresponding to the first group and having a smallest prediction error as the second machine learning model corresponding to the first group.

11. A parameter generation apparatus for a printer, comprising:
a storage storing a code; and
a processor, coupled to the storage, loading the code and executing:
inputting a target solder paste amount data into a first machine learning model, wherein the first machine learning model outputs a plurality of predicted process parameters for the printer;
inputting the plurality of predicted process parameters into a second machine learning model, wherein the second machine learning model generates a predicted solder paste amount data for the printer, and the second machine learning model is trained to learn an association between a plurality of solder paste amount samples and a plurality of parameter samples;
according to a minimization of a prediction error, updating a weight of the first machine learning model, wherein the prediction error is an error between the target solder paste amount data and the predicted solder paste amount data; and
inputting the target solder paste amount data into the updated first machine learning model, wherein the updated first machine learning model outputs a plurality of new process parameters, and the plurality of new process parameters are used to control an operation of the printer.

12. The parameter generation apparatus for the printer according to claim 11, wherein the processor further executes:
using a loss function to determine the prediction error, wherein the loss function is a half a square of a numerical difference between the target solder paste amount data and the predicted solder paste amount data.

13. The parameter generation apparatus for the printer according to claim 11, wherein the plurality of new process parameters comprise a plurality of printing parameters used in the operation of the printer, and the target solder paste amount data comprises a solder paste amount used for a metal board.

14. The parameter generation apparatus for the printer according to claim 13, wherein a type of the plurality of printing parameters comprises a pressure, a print speed, a separate speed, a separation distance, a print gap, and a clean rate.

15. The parameter generation apparatus for the printer according to claim 11, wherein the processor further executes:
inputting a plurality of features to be evaluated into a third machine learning model to generate a hole solder paste amount data for the printer, wherein the third machine learning model is trained to learn an association between a plurality of hole features and a solder paste amount, the plurality of hole features comprises an opening ratio of a plurality of holes on a metal board and a plurality of distribution positions of the plurality of holes on the metal board, and the hole solder paste amount data comprises the solder paste amount used for the plurality of holes.

16. The parameter generation apparatus for the printer according to claim 11, wherein the processor further executes:
using the first machine learning model to output an initial parameter;
converting the initial parameter into a controllable value using a transfer function, wherein the transfer function is a step function; and
normalizing the controllable value into the predicted process parameter.

17. The parameter generation apparatus for the printer according to claim 16, wherein the step function is formed by adding a plurality of sigmoid functions.

18. The parameter generation apparatus for the printer according to claim 11, wherein the processor further executes:
inputting the plurality of predicted process parameters and an auxiliary parameter into the second machine learning model, wherein a type of the auxiliary parameter comprises a temperature, a humidity, and a positioning position of a metal board in the printer.

19. The parameter generation apparatus for the printer according to claim 11, wherein the processor further executes:
determining that a metal board physical feature belongs to a first group of a plurality of metal board groups, wherein a type of the metal board physical feature is related to a size of a metal board and an area and a thickness of a plurality of holes on the metal board; and
selecting the second machine learning model corresponding to the first group to generate the predicted solder paste amount data.

20. The parameter generation apparatus for the printer according to claim 19, wherein the processor further executes:
providing a plurality of the second machine learning models, wherein each of the plurality of second machine learning models corresponds to one of a plurality of historical metal board physical information, and the one of the plurality of historical metal board physical information corresponding to any of the plurality of second machine learning models differs from another one of the plurality of historical metal board physical information corresponding to another one of plurality of the second machine learning models;
grouping the plurality of historical metal board physical information into the plurality of metal board groups; and
for the first group of the plurality of metal board groups, selecting one of the plurality of second machine learning models corresponding to the first group and having a smallest prediction error as the second machine learning model corresponding to the first group.
